(19) United States
(12) Patent Application Publication
(10) Pub. No.: US 2009/0006557 A1
(43) Pub. Date: Jan. 1, 2009

(54) REMOTE PROGRAMMING OF AN AUTOMATIC REPLY FEATURE IN AN EMAIL ACCOUNT

(76) Inventors: Cynthia K. Florkey, Ft. Collins, CO (US); Karen A. Hotze, Northfield, IL (US)

Correspondence Address: DUFT BORNSEN & FISHMAN, LLP, 1526 SPRUCE STREET, SUITE 302, BOULDER, CO, 80302, US

(21) Appl. No.: 11/769,153

(22) Filed: Jun. 27, 2007

(51) Int. Cl. G06F 15/16; H04L 9/32

(52) U.S. Cl. 709/206; 726/2

(57) ABSTRACT

Systems and methods are disclosed for providing remote programming of an automatic reply feature in an email account through a communication device, such as a landline phone, a mobile phone, etc. An automatic reply server is implemented in a communication network, such as a PSTN, a cellular network, etc. The user of a communication device may access the automatic reply server with instructions to program the automatic reply feature of his/her email account. Responsive to the instructions, the automatic reply server formats the appropriate program message, and transmits the program message to the email server that is hosting the email account. The email server then programs the automatic reply feature in the email account of the user based on the program message, such as by activating or deactivating the automatic reply feature, defining a message to include in the reply emails, etc.

### BACKGROUND

1. Field of the Invention

The invention relates to the field of communications, and in particular, to remotely programming an automatic reply feature, such as an Out of Office Assistant, in an email account, such as through a landline phone, a mobile phone, etc.

2. Statement of the Problem

Email has become a popular type of communication. To send and receive emails, a user sets up an email account on an email server. The user accesses the email account through an email application that runs on his/her client device, such as a computer. One particular example of an email application is Microsoft Outlook®. The email application periodically retrieves emails from the email server such as through Post Office Protocol version 3 (POP3) requests. The user may then view the emails through the user interface provided by the email application.

One particular feature provided in many email accounts is an automatic reply feature. The automatic reply feature, also referred to as an Out of Office Assistant, a vacation response feature, etc, is a service that automatically responds to received emails with a reply email. An email user may program the automatic reply feature to send reply emails that acknowledge receipt of an email, that provide alternate contact information, that indicate when an email response can be expected, etc.

To implement the automatic reply feature, the user accesses the proper menu provided by the email application to activate the automatic reply feature. The user may also define a start date and end date for the activation, may define a message to include in the reply emails, or may define other parameters. The email application then transmits a program message to the email server indicating that the automatic reply feature has been activated. Responsive to the program message, the email server activates the automatic reply feature. When the automatic reply feature is activated in the email account, the email server will respond to emails received in the email account of the user with a reply email.

One problem with automatic reply features presently provided is that the user has to program the automatic reply feature through the email application on his/her computer. For example, if the user wants to activate the automatic reply feature, the user has to do so through the email application. If the user does not have access to the email application, such when the user is away from his/her computer, then the user cannot program the automatic reply feature.

### SUMMARY OF THE SOLUTION

Embodiments of the invention solve the above and other problems by providing for remote programming of an automatic reply feature in an email account through a communication device, such as a landline phone, a mobile phone, etc. As provided herein, an automatic reply server is implemented in a communication network, such as a PSTN, a cellular network, etc. The user of a communication device may access the automatic reply server with instructions to program the automatic reply feature in his/her email account. Responsive to the instructions, the automatic reply server formats the appropriate program message, and transmits the program message to the email server that is hosting the email account of the user. The email server then programs the automatic reply feature in the email account of the user based on the program message, such as by activating the automatic reply feature, deactivating the automatic reply feature, defining a message to include in the reply emails, etc. Through this remote programming of the automatic reply feature, a user no longer needs to return to his or her computer and program the automatic reply feature through the email application. The user can advantageously program the automatic reply feature from virtually any location.

One embodiment of the invention comprises an automatic reply server that is implemented in a communication network. The automatic reply server receives a communication, such as a phone call, a text message, etc, from a communication device to program the automatic reply feature in an email account of the user. Responsive to the communication from the user, the automatic reply server identifies the email account of the user on an email server. The automatic reply server then identifies instructions from the user to program the automatic reply feature in the email account. The instructions may comprise activating or deactivating the automatic reply feature, defining a start date and end date for activating the automatic reply feature, defining a message to be included in reply emails, etc. The automatic reply server then formats a program message to program the automatic reply feature according to the instructions of the user, and transmits the program message to the email server that is hosting the email account of the user. The email server may then program the automatic reply feature in the email account of the user according to the instructions included in the program message from the automatic reply server.

The invention may include other exemplary embodiments described below.

### DESCRIPTION OF THE DRAWINGS

The same reference number represents the same or similar element on all drawings.

FIG. 1 illustrates an email network and a communication network in an exemplary embodiment of the invention.

FIG. 2 is a flow chart illustrating a method of operating an automatic reply server to remotely program an automatic reply feature in an exemplary embodiment of the invention.

FIG. 3 is a flow chart illustrating a method of operating an email server to remotely program an automatic reply feature in an exemplary embodiment of the invention.

### DETAILED DESCRIPTION OF THE INVENTION

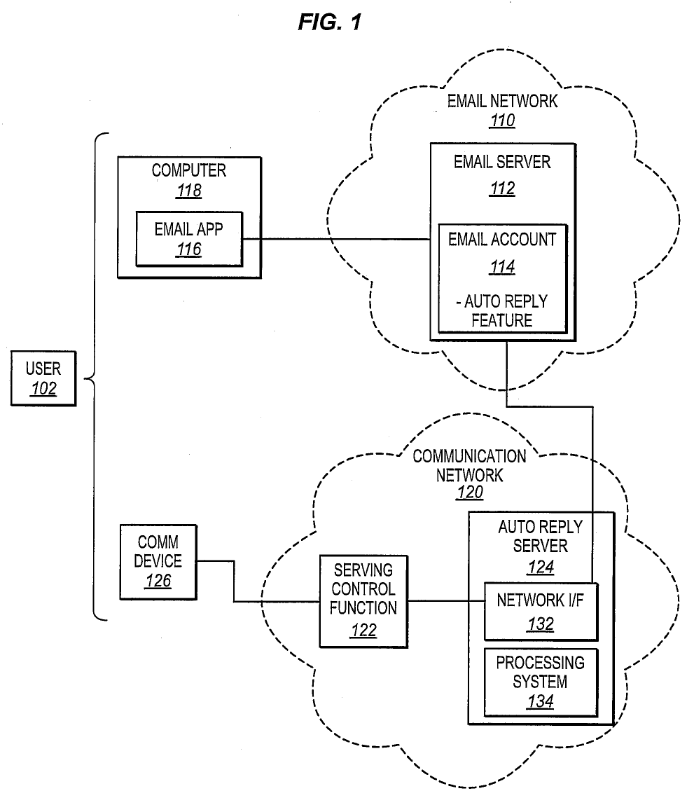

FIGS. 1-3 and the following description depict specific exemplary embodiments of the invention to teach those skilled in the art how to make and use the invention. For the purpose of teaching inventive principles, some conventional aspects of the invention have been simplified or omitted. Those skilled in the art will appreciate variations from these embodiments that fall within the scope of the invention. Those skilled in the art will appreciate that the features described below can be combined in various ways to form multiple variations of the invention. As a result, the invention is not limited to the specific embodiments described below, but only by the claims and their equivalents.

FIG. 1 illustrates an email network 110 and a communication network 120 in an exemplary embodiment of the invention. Email network 110 includes an email server 112 that is hosting an email account 114 of a user 102. Email account 114 includes an automatic reply feature that is adapted to automatically respond to incoming or received emails that are destined for email account 114 with reply emails. User 102 is able to access email account 112 through email application 116 that is being executed on computer 118. As is commonly done, user 102 may program the automatic reply feature in email account 114 through email application 116. For instance, user 102 may access the proper menu provided by email application 116 to activate the automatic reply feature. User 102 may also define a start date and end date for the activation, may define a message to include in the reply emails, or may define other parameters.

Communication network 120 in FIG. 1 includes a serving control function 122 and an automatic reply server 124. Communication network 120 may comprise a PSTN, a cellular network, an IMS network, or another type of network. Serving control function 122 comprises any server, router, switch, or other system adapted to serve a communication device 126 for communications. For example, serving control function 122 may comprise a Mobile Switching Center (MSC) in a cellular network, or may comprise a Call Session Control Function (CSCF) in an IMS network. Automatic reply server 124 comprises any server, application, or other system adapted to receive instructions to program an automatic reply feature of an email account, and provide the instructions to an email server, such as email server 112. Automatic reply server 124 includes a network interface 132 and a processing system 134. Automatic reply server 124 may be implemented in an existing server in communication network 120, such as a in voice mail server, or may be implemented in a stand-alone server.

According to embodiments provided herein, user 102 is able to remotely program the automatic reply feature in email account 114 through communication device 126. Communication device 126 may comprise a landline phone, a mobile phone, a PDA, or another type of communication device. Although many communication devices are capable of executing an email application, much like computer 118 executes email application 116, communication device 126 is not executing an email application to remotely program the automatic reply feature as provided herein. The concept of “remotely programming” the automatic reply feature of an email account means to program the automatic reply feature through some type of communication in communication network 120 and not through an email application. The automatic reply feature is instead programmed through some other means, such as by user 102 placing a call to automatic reply server 124, transmitting a text message to automatic reply server 124, etc.

To program the automatic reply feature, user 102 initiates a communication with automatic reply server 124 through communication device 126. For instance, user 102 may place a phone call to automatic reply server 124, such as by dialing an 800 number for automatic reply server 124. User 102 may alternatively initiate a text message addressed to automatic reply server 124.

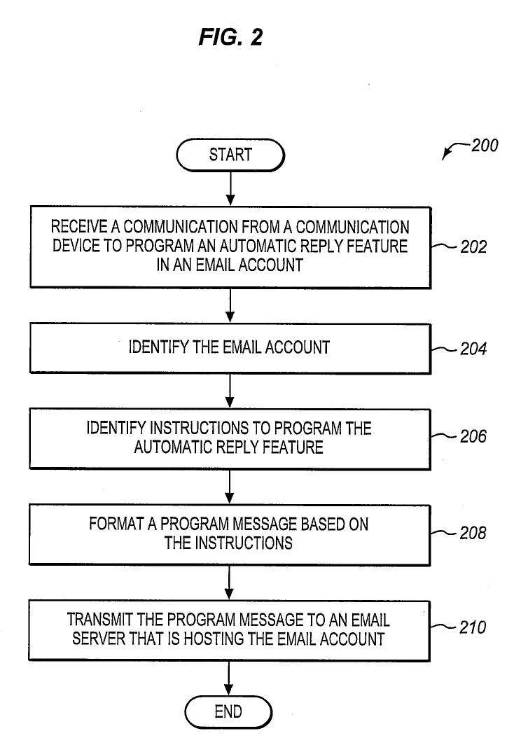

FIG. 2 is a flow chart illustrating a method 200 of operating automatic reply server 124 to remotely program the automatic reply feature in an exemplary embodiment of the invention. The steps of method 200 will be described with reference to FIG. 1. The steps of the flow chart in FIG. 2 are not all inclusive and may include other steps not shown.

In step 202 of method 200, processing system 134 receives the communication from communication device 126 through network interface 132 to program the automatic reply feature in email account 114. In step 204, processing system 134 identifies the email account 114 of user 102 on email server 112. Processing system 134 may identify the email account 114 in a variety of ways. In one example, user 102 may have pre-provisioned data in automatic reply server 124 indicating the email account 114 (i.e., an email address), a network address for email server 112, a directory number for user 102, and possibly other data. The communication received from communication device 126 may include information that indicates the email account or includes information that may be used to derive the email account. For instance, the communication received from communication device 126 may include a directory number for user 102. Processing system 134 may then process the directory number of user 102 to identify the email account 114 for user 102. In another instance, user 102 may format a text message that includes his/her email address. Processing system 134 may then identify the email account 114 by processing the text message to identify the email address as provided by user 102. In another example, processing system 134 may prompt user 102 for the identity of the email account 114 responsive to which user 102 enters his/her email address into communication device 126.

In step 206, processing system 134 identifies instructions from user 102 to program the automatic reply feature in the email account 114. The instructions may comprise activating or deactivating the automatic reply feature. The instructions may also comprise a start date and end date for activating the automatic reply feature. The instructions may also comprise a message to be included in reply emails. For example, the message may convey “Out of the office for the day”. The instructions may comprise a message identifier that corresponds with predefined or canned messages stored in automatic reply server 124. The instructions may program any other parameters of the automatic reply feature.

Processing system 134 may identify the instructions from user 102 in a variety of ways. In one example, user 102 may include the instructions in the communication to automatic reply server 124. For instance, user 102 may format a text message that includes the instructions to program the automatic reply feature. User 102 may insert a special code or text string that represents the instructions. Processing system 134 may then process or parse the text message to identify the instructions as provided by user 102. In another example, assume that user 102 places a call to automatic reply server 124 through communication device 126. Responsive to answering the call, processing system 134 may use Interactive Voice Response (IVR) technology or another means to prompt user 102 for the instructions. For instance, processing system 134 may provide a menu of programming options to user 102. The menu of options may be “Press 1 to activate the automatic reply feature, Press 2 to deactivate the automatic reply feature”. User 102 may then select the desired option, and the selection is interpreted by processing system 134. Processing system 134 may identify other information from user 102, such as a login ID for email account 114, a password for email account 114, or other information.

In step 208, processing system 134 formats a program message to program the automatic reply feature according to the instructions of user 102. The program message may comprise a Session Initiation Protocol (SIP) message or a message of another protocol. Processing system 134 formats the program message according to a particular format understood by email server 112. For instance, email server 112 may require a login ID and password for email account 112 before access is granted to the account. Processing system 134 may thus format the program message to include this information. Email server 112 may also need some type of instructions to program the automatic reply feature. Processing system 134 may thus format the program message to include the proper instructions to program the automatic reply feature. Processing system 134 may store the formats understood by one or more email servers 112. If the format for email server 112 is not stored, then processing system 134 may query a server to acquire the appropriate format.

In step 210, processing system 134 transmits the program message to email server 112. To transmit the program message, processing system 134 identifies a network address for email server 112. The network address may be pre-provisioned by user 102, or processing system 134 may query user 102 or a server/database to identify the network address of email server 112.

Before transmitting the program message, processing system 134 may authenticate user 102 through some type of authentication information, such as a user ID, a password, a pin number, a directory number, etc. For instance, just as user 102 has a login ID and password for email server 112, user 102 may also have a user ID and/or password for automatic reply server 124. User 102 may include the user ID and password in the original communication to automatic reply server 124. Automatic reply server 124 may alternatively prompt user 102 for the user ID and password.

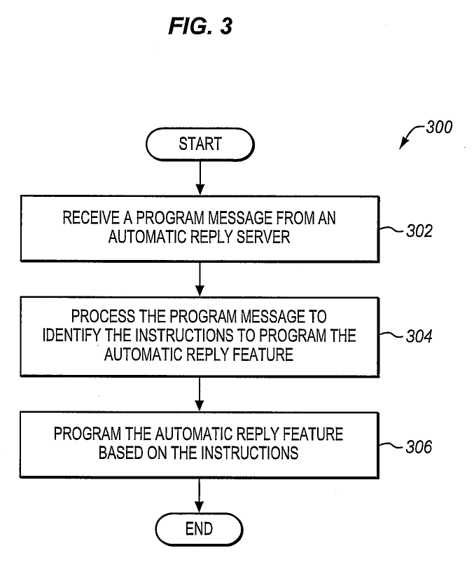

FIG. 3 is a flow chart illustrating a method 300 of operating email server 112 to remotely program the automatic reply feature in an exemplary embodiment of the invention. The steps of method 300 will be described with reference to FIG. 1. The steps of the flow chart in FIG. 3 are not all inclusive and may include other steps not shown.

In step 302 of method 300, email server 112 receives the program message from automatic reply server 124. In step 304, email server 112 processes the program message to identify the instructions to program the automatic reply feature in email account 114 of user 102. In processing the program message, email server 112 may first identify the email account 114 of user 102 from information in the program message. Email server 112 may then authenticate user 102 through a login ID and password that is included in the program message. If user 102 is authenticated, then email server 112 programs the automatic reply feature in email account 114 based on the instructions included in the program message in step 306.

This process of remotely programming the automatic reply feature allows user 102 to program the automatic reply feature from virtually any location through communication device 126. User 102 does not need access to computer 118 to program the automatic reply feature through email application 116.

The following describes an example of remotely programming the automatic reply feature in email account 114. Assume for example that user 102 is going to be out of the office for a week, but forgot to activate the automatic reply feature on email account 114 to respond to incoming emails indicating as such. To remotely activate the automatic reply feature, user 102 places a call to automatic reply server 124 through communication device 126. Responsive to the call, automatic reply server 124 prompts user 102 for a user ID, a password, a pin number, or some other authentication information. User 102 provides the authentication information to automatic reply server 124 through communication device 126, such as by speaking the information, entering the information through a keypad on communication device 126, etc. Automatic reply server 124 then authenticates user 102 and identifies a profile for user 102. The profile may include any pre-provisioned information that user 102 has provided, such as information on email account 114 (e.g., an email address, a login ID, and a password), information on email server 112 (e.g., a network address and a programming format understood by email server 112). Through the profile stored for user 102, automatic reply server 124 identifies the email account 114 of user 102 and the location of the email account 114.

Automatic reply server 124 then prompts user 102 for instructions on how to program the automatic reply feature. For instance, automatic reply server 124 may provide a menu of programming options to user 102. The menu of options may be “Press 1 to activate the automatic reply feature, Press 2 to deactivate the automatic reply feature”. Because user 102 desires to activate the automatic reply feature, user 102 presses “1” on the keypad of communication device 126. Automatic reply server 124 receives the selection by user 102 and identifies the instruction from user 102 to activate the automatic reply feature. Automatic reply server 124 also prompts user 102 for a message to include in the reply emails that will be sent through the automatic reply feature. Responsive to the prompt, user 102 may speak a desired message, such as “I will be out of the office for a week”. Automatic reply server 124 receives the message as spoken by user 102. Automatic reply server 124 then formats a program message that includes the instruction to activate the automatic reply feature, and the instruction to include the message “I will be out of the office for a week” in the reply emails. Automatic reply server 124 then transmits the program message to email server 112.

Responsive to receiving the program message, email server 112 identifies the email account of the user 102 based on information included in the program message. Email server 112 also authenticates user 102, such as by processing a login ID and password that is included in the program message. If user 102 is authenticated, then email server 112 programs the automatic reply feature according to the instructions in the program message. In this example, email server 112 activates the automatic reply feature and defines a message of “I will be out of the office for a week” for the reply emails.

If email server 112 subsequently receives an email addressed to email account 114, then email server 112 will automatically transmit a reply email to the sender. The reply email will include the message of “I will be out of the office for a week”. User 102 may use a similar process to deactivate the automatic reply feature or to change or update the message that will be sent in the reply emails.

Although specific embodiments were described herein, the scope of the invention is not limited to those specific embodiments. The scope of the invention is defined by the following claims and any equivalents thereof.

We claim:

1. A method of remotely programming an automatic reply feature in an email account of a user, the method comprising:
receiving a communication from the user through a communication device to program the automatic reply feature in the email account of the user;
identifying the email account of the user on an email server responsive to the communication;
identifying instructions from the user to program the automatic reply feature in the email account;
formatting a program message to program the automatic reply feature according to the instructions of the user; and
transmitting the program message to the email server.

2. The method of claim 1 further comprising:
authenticating the user prior to transmitting the program message to the email server.

3. The method of claim 1 wherein identifying the email account of the user comprises:
identifying the email account of the user based on information received in the communication from the user.

4. The method of claim 1 wherein identifying the email account of the user comprises:
prompting the user for the identity of the email account.

5. The method of claim 1 wherein identifying instructions from the user to program the automatic reply feature comprises:
identifying the instructions based on information received in the communication from the user.

6. The method of claim 1 wherein identifying instructions from the user to program the automatic reply feature comprises:
prompting the user for the instructions.

7. The method of claim 1 wherein the instructions comprise at least one of activating the automatic reply feature, defining a start/end time for activating the automatic reply feature, and deactivating the automatic reply feature.

8. The method of claim 1 wherein the instructions include an indication of a message to be included in a reply email.

9. An automatic reply server adapted to remotely program an automatic reply feature in an email account of a user, the automatic reply server comprising:
a network interface adapted to receive a communication from the user through a communication device to program the automatic reply feature in the email account of the user; and
a processing system adapted to identify the email account of the user on an email server responsive to the communication from the user, to identify instructions from the user to program the automatic reply feature in the email account, to format a program message to program the automatic reply feature according to the instructions of the user, and to transmit the program message to the email server.

10. The automatic reply server of claim 9 wherein the processing system is further adapted to:
authenticate the user prior to transmitting the program message to the email server.

11. The automatic reply server of claim 9 wherein the processing system is further adapted to:
identify the email account of the user based on information received in the communication from the user.

12. The automatic reply server of claim 9 wherein the processing system is further adapted to:
prompt the user for the identity of the email account.

13. The automatic reply server of claim 9 wherein the processing system is further adapted to:
identify the instructions based on information received in the communication from the user.

14. The automatic reply server of claim 9 wherein the processing system is further adapted to:
prompt the user for the instructions.

15. The automatic reply server of claim 9 wherein the instructions comprise at least one of activating the automatic reply feature, defining a start/end time for activating the automatic reply feature, and deactivating the automatic reply feature.

16. The automatic reply server of claim 9 wherein the instructions include an indication of a message to be included in a reply email.

17. A method of remotely programming an automatic reply feature in an email account of a user, the method comprising:
receiving a communication in an automatic reply server from the user through a communication device to program the automatic reply feature in the email account of the user;
identifying the email account of the user on an email server responsive to the communication;
identifying instructions from the user to program the automatic reply feature in the email account;
formatting a program message to program the automatic reply feature according to the instructions of the user;
transmitting the program message to the email server;
processing the program message in the email server to identify the instructions to program the automatic reply feature; and
programming the automatic reply feature in the email account of the user based on the instructions.

18. The method of claim 17 further comprising:
authenticating the user in the automatic reply server prior to transmitting the program message to the email server.

19. The method of claim 17 wherein programming the automatic reply feature in the email account of the user comprises:
activating or deactivating the automatic reply feature.

20. The method of claim 17 wherein programming the automatic reply feature in the email account of the user comprises:
defining a message to be included in a reply email.
